(19) United States
(12) Patent Application Publication
(10) Pub. No.: US 2014/0091918 A1
(43) Pub. Date: Apr. 3, 2014

(54) Wear Detection System and Method

(71) Applicants: Daniel Pfeffer, Mücke (DE); Jürgen Spies, Langgöns (DE); Stefan Nettesheim, Berlin (DE); Sven Jakubith, Berlin (DE); Guntram Fleischhauer, Lohra/Kirchvers (DE); Timo Staubach, Herbstein (DE)

(72) Inventors: Daniel Pfeffer, Mücke (DE); Jürgen Spies, Langgöns (DE); Stefan Nettesheim, Berlin (DE); Sven Jakubith, Berlin (DE); Guntram Fleischhauer, Lohra/Kirchvers (DE); Timo Staubach, Herbstein (DE)

(21) Appl. No.: 14/003,580

(22) PCT Filed: Feb. 10, 2012
(86) PCT No.: PCT/EP2012/052291

§ 371 Date: Dec. 17, 2013

(30) Foreign Application Priority Data
Mar. 9, 2011 (DE) 10 2011 005 302.6

(51) Int. Cl. F16D 66/02

(52) U.S. Cl. CPC F16D 66/021
USPC 340/454

(57) ABSTRACT

The invention relates to a wear detection system (10) and to a method for detecting wear, in particular for friction elements, such as brushes, friction linings, brake linings, lubrication pieces or the like, comprising at least one consumable friction element and a transponder unit (11), wherein the transponder unit can communicate wirelessly with a transmitter-receiver unit (12), the wear detection system comprising a shielding device, the shielding device being configured in such a manner that the transponder unit can be at least partially shielded by means of the shielding device as a function of a wear condition of the friction element, such that communication between the transponder unit and the transmitter-receiver unit can be influenced.

The invention relates to a wear detection system and to a method for detecting wear, in particular for friction elements, such as brushes, friction linings, brake linings, lubrication pieces or the like, comprising at least one consumable friction element, and a transponder unit, wherein the transponder unit can communicate wirelessly with a transmitter-receiver unit.

Friction elements, such as carbon brushes for electric motors, friction linings for force transmission, brake linings and solid lubricant pieces, and contact strips for rail vehicles are always subject to wear by abrasion of material of the friction element. Often it is desirable to replace the friction element before it reaches a wear limit detrimental to function. Hence, wear detection systems are commonly used for monitoring a wear condition of friction elements. In this context, electric contacts on friction elements are known, as well as switches, which can signal the arrival at a wear limit. However, wear detection systems of this sort require a wiring of the contacts and switches to a control unit. Such a wiring can only be produced in a relatively costly manner, in particular in cases where a plurality of friction elements is to be monitored simultaneously. Thus, a wiring, for example for brushes of a generator, can also be configured in the manner of a series connection so as to reduce the wiring effort. Then, however, the wear detection system can no longer recognize which brush triggered the respective signal.

Furthermore, it is known to provide friction elements with a transponder unit that can communicate wirelessly with a transmitter-receiver unit, thus omitting an elaborate wiring of the friction elements. DE 10 2007 009 423 A1 discloses such a wear detection system, in which a carbon brush is provided with a transponder unit. When a wear limit of the carbon brush is reached, the transponder unit is destroyed by the contact to a friction surface against which the carbon brush abuts. The carbon brush can then no longer be detected by a transmitter-receiver unit, which causes the latter to recognize the carbon brush as worn. It can also be provided that the transponder unit comprises measuring sensors for determining a temperature of the carbon brush, their data being transmitted from the transponder unit to the transmitter-receiver unit.

The known wear detection system has the disadvantage that a destruction of the transponder unit upon arrival at a wear limit is absolutely necessary. Thus, the transponder unit has to be formed or attached to the carbon brush in such a manner that it is surely destroyed when it reaches the wear limit or the friction surface. Hence, inexpensive transponder units, such as those available in the form of tags, cannot be used here since the tags could come off due to the heat influence in direct proximity of the friction surface or they might not be mechanically destroyed because of insufficient adhesion to the carbon brush.

Also, detailed information on a wear condition of a friction element can only be obtained prior to the arrival at a wear limit if a transponder unit is additionally equipped with measuring sensors. For instance, the transponder unit can be attached to a friction element at any given position well suited for mounting, the transponder unit being connected for example via cables to a measuring sensor or to a simple contact installed in the area of a wear limit of the friction element. Thus, transponder units that require destruction can only be attached in a complicated manner and those equipped with measuring sensors and connection cables are comparatively expensive.

Therefore, it is the object of the present invention to propose a wear detection system and a method for detecting wear which makes it possible to monitor the wear of friction elements in a cost-effective and simple manner.

This object is attained by a wear detection system comprising the features of claim 1 and a method for detecting wear comprising the features of claim 14.

The wear detection system according to the invention, in particular for friction elements, such as brushes, friction linings, brake linings, lubrication pieces or the like, comprises at least one consumable friction element and a transponder unit, wherein the transponder unit can communicate wirelessly with a transmitter-receiver unit, the wear detection system comprising a shielding device, the shielding device being configured in such a manner that the transponder unit can be shielded at least partially by means of the shielding device as a function of a wear condition of the friction element, such that communication between the transponder unit and the transmitter-receiver unit can be influenced.

By influencing the transponder unit by means of a shielding device formed independent thereof, it is possible to change or block a communication link between the transponder unit and the transmitter-receiver unit or to enable said link in the first place. Since the signal of the transponder unit, which is received by the transmitter-receiver unit, is influenced in substance only by the shielding device, almost any kind of transponder unit can be used, in particular a cost-effective transponder unit. Further, communication between the transponder unit and the transmitter-receiver unit is substantially simplified because the content of the transmitted data is generally immaterial. It is only important that the transponder unit is actually detected and recognized by the transmitter-receiver unit. Also, for implementing the shielding device, integration of a new component or of a new structural unit is not necessarily required. Instead, the components present anyway in the vicinity of the friction element can be used for forming the shielding device so that no additional costs arise. It is then no longer necessary, either, to attach the transponder unit directly to the friction element or to attach the transponder unit to the friction element in such a manner that a destruction of the transponder unit is ensured. The arrival at a wear limit of the friction element is detectable by the transmitter-receiver unit due to a change of a response signal of the transponder unit or, alternatively, due to an absence of the transponder signal after it was previously received or due to receiving the transponder signal after its previous absence.

In one embodiment, the transponder unit can have a coding that can be received by the transmitter-receiver unit. The coding can be used as a switching signal, for example in order to be able to activate a machine. If a friction element not having a predefined coding is installed in the machine, no corresponding signal can be generated and in consequence the machine cannot be activated. Thus, it is ensured that only friction elements approved for said machine can be used. In cases where a plurality of friction elements is employed, it is further also possible to determine which of the friction elements has failed or is worn if each friction element has an individual coding by means of the transponder unit. For such control purposes, the wear detection system can be connected to a control unit or to a machine control.

Advantageously, the transponder unit can be an RFID transponder unit. While it is also conceivable to use a transponder unit that is based, for example, on optical transmission technology, RFID transponder units are comparatively cost-effective and additionally available in the form of sticker labels. Preferably, passive RFID transponder units can be employed because they do not require an external power supply. Further, a radio signal between the RFID transponder unit and the transmitter-receiver unit can be influenced in an uncomplicated manner by means of the shielding device. For instance, a resonance frequency of an antenna of the RFID transponder unit can be easily influenced by covering the antenna or by an electric conductor in the vicinity of the antenna, such that the radio signal is strongly attenuated or shielded completely.

The friction element can, for example, be a contact piece for transferring electric energy, such as a carbon brush for an electric motor or generator. The wear detection system can be used particularly effectively in cases where an electric motor is provided with a plurality of carbon brushes which have to be replaced regularly due to wear or damage. A wear detection system of this sort can be advantageously employed in particular where maintenance of the carbon brushes is difficult, for example in a wind power plant. From a purely basic point of view, however, the wear detection system can also be used for other types of friction elements, such as all kinds of friction linings, brake linings or for dry lubrication elements.

A controlled shielding of the transponder unit can be made possible in that the shielding device is arranged directly adjacent to the transponder unit. If the transponder unit comprises an antenna, the latter can be directly shielded by means of a material interacting with electromagnetic radiation, such as a metal material, or by the material of the friction element itself. The material or the shielding device formed thereof can always completely cover the transponder unit, a permittivity of the shielding device then being formed irregularly relative to the transponder unit so that at least in one position of the transponder unit relative to the shielding device, or in case of a total or partial removal of the shielding device, communication with the transmitter-receiver unit is possible. In conclusion, by directly arranging the shielding device in proximity to the transponder unit, a positional change of the friction element relative to the shielding device and/or to the transponder unit can be detected due to communication of the transponder unit with the transmitter-receiver unit.

In a further development of the wear detection system, the latter can comprise a support structure which serves to movably position the friction element relative to a friction surface and to contact the friction element with the friction surface. The friction element can thus be supported or accommodated by the support structure and be pressed against a friction surface, for example by a spring device or an actuator exerting a pressure force. For example, the friction element can be formed monolithic, having a cubic form, or also in the shape of a rod and be accommodated by the support structure in such a manner that it can be moved in the support structure in a substantially orthogonal manner relative to the friction surface. The reduction in length caused by the wear of the friction element and the longitudinal motion of the friction element relative to the support structure can then influence communication between the transponder unit and the transmitter-receiver unit by means of the shielding device.

In an advantageous embodiment, the transponder unit can be immovably connected to the friction element, the shielding device being formed by the support structure or by at least one opening in the support structure, wherein said opening can be formed such that in case of an at least partial overlapping of the opening with the transponder unit, a communication between the transponder unit and the transmitter-receiver unit is changed, blocked or enabled. In this context, it is in particular not required that the transponder unit is connected especially tightly with the friction element because the transponder unit does not necessarily have to be destroyed and can only be used for detecting a motion of the friction element relative to the friction surface. If the support structure forms the shielding device, the transponder unit or a possibly present antenna of the transponder unit can be covered by the support structure in a specific position of the friction element relative to the friction surface and thus be shielded. The opening in the support structure therefore serves the purpose of exposing the transponder unit and of enabling communication of the latter with the transmitter-receiver unit. The opening can be formed as a simple passage hole in a side wall of the support structure, the passage hole being especially easy to produce, for example as a bore hole. Further, the opening can also be an opening already present in the support structure at a front side of the support structure into which the friction element is inserted. The transponder unit can enable and interrupt communication with the transmitter-receiver unit when exiting or entering the support structure. Alternatively, it is also possible that the opening of the support structure is formed in the manner of a tapering slot. Then it becomes possible to detect a changing, weakening or increasing signal of the transponder unit by means of the transmitter-receiver unit so as to determine and measure an actually present wear condition of the friction element.

Also, the support structure can have a plurality of openings which form the shielding device. Thus, it becomes possible to detect a position of the friction element relative to the support structure so as to determine a wear progression relatively exactly. The openings can for example be formed as a row of bore holes in longitudinal direction of a side wall of the support element. It is also conceivable to vary the size of the passage holes so as to detect differently strong ingoing signals of the transponder unit, from which, in turn, conclusions can be drawn concerning a relative position of the friction element. The differently strong signals can be determined by means of a time delay in the responses of the transponder unit to signals of the transmitter-receiver unit. A response can be further delayed for example by a weak signal because a response of a passive RFID transponder unit first requires loading a capacitor of the transponder unit and loading time depends on a received signal strength.

The wear detection system can be realized in a particularly simple and cost-effective manner if the transponder unit is arranged on a surface of the friction element. For example, the transponder unit can be formed in the manner of a sticker label, which only needs to be stuck onto the friction element or a surface thereof. Special measures for attaching the transponder unit to the friction element are then no longer required.

Alternatively, the transponder unit can also be arranged inside the friction element. This means that the transponder unit can be accommodated as a whole within the friction element, for example by embedding the transponder unit in the material of the friction element during production thereof, or also be inserted into a bore hole in the friction element. This is particularly advantageous if the transponder unit is to be protected against damaging exterior influences. Further, it is also possible to arrange multiple transponder units within the friction element. This is particularly advantageous if the friction element is not worn uniformly because then a section of the friction element with maximal wear can be monitored or detected, too.

In another embodiment of the wear detection system, the transponder unit can be immovably connected to the support structure, wherein the shielding device can be realized as a shielding element which is arranged at the support structure and which can cover or uncover the transponder unit in a shielding manner when a motion of the friction element relative to the support structure takes place. Accordingly, the transponder unit can for example be attached directly to a surface of the support structure without the transponder unit being in contact with the friction element. The shielding device can then be formed by a shielding element which, as a function of, for example, a change in length of the friction element, covers the transponder unit in a shielding manner or uncovers it for communication with the transmitter-receiver unit. The shielding element can be formed for example as a simple metal sheet, which is moved relative to the transponder unit after having passed an end of the friction element. A shielding device of this sort can be realized cost-effectively, too, and allows a particularly secure transmission and communication between the transponder unit and the transmitter-receiver unit because being separate from the friction element, the transponder unit is not exposed to high temperatures or vibrations. In particular in cases where the support structure is formed from a plastic material, then also a resonance frequency of, for example, an RFID transponder unit is barely influenced by ambient materials except for the shielding device.

The friction element can also be a contact strip for transferring electric energy from a contact wire to a vehicle. Contact strips of this sort are commonly used on rail vehicles and contacted with the contact wire by means of a pantograph. The pantograph in this context corresponds to the support structure, wherein a wear condition of the contact strip cannot be detected by means of the transponder unit solely from a change of the distance of the pantograph in relation to the contact wire. It can rather be envisaged that the transponder unit is arranged in the contact strip in such a manner that in case of an abrasion of the contact strip, the transponder unit is uncovered and thus, for example by means of transmitter-receiver units positioned in proximity of the contact wire, a wear of the contact strip can be detected. Thus, the shielding device can be formed by the contact strip itself.

The support structure according to the invention is configured for a wear detection system according to any of the claims 6 to 11. Further advantageous embodiments arise from the feature descriptions of the respective dependent claims.

In the method for detecting wear according to the invention, in particular for friction elements, such as brushes, friction linings, brake linings, lubrication pieces or the like, comprising at least one consumable friction element and a transponder unit, the transponder unit can communicate wirelessly with a transmitter-receiver unit, the transponder unit being at least partially shielded by means of a shielding device as a function of a wear condition of the friction element, such that communication between the transponder unit and the transmitter-receiver unit is influenced. A wear-related change of length of the friction element can thus cause a change in position of the transponder unit relative to the shielding device. Regarding the advantages of the method for detecting wear, reference is made to the detailed description of the wear detection system according to the invention.

The method can be implemented in a particularly simple manner if the shielding device changes a permittivity of a spatial transmission range of the transponder unit. For instance, the shielding device can be arranged in the space which is interposed between the transponder unit and the transmitter-receiver unit and which is used for transmitting in- or out-going signals, and influence the in- and outgoing signals by changing the permittivity of the respective space. In electromagnetic transmission methods, this can take place for example by introducing electrically conductive materials into said space or by correspondingly removing them. When this happens as a function of a wear condition of the friction element, it is possible to draw conclusions concerning a wear condition from a change in permittivity.

This can also be achieved by means of a wear-related dimensional change of the friction element, by which a shielding or an elimination of a shielding of the transponder unit can take place. A wear of the friction element caused by abrasion is accompanied by a dimensional change of the friction element, wherein the dimensional change, such as a change in length or an abrasion of a surface, can result in the transponder unit being shielded, or selectively in the shielding of the transponder being eliminated. Thus, a wear of the friction element is accompanied by a change of the ingoing signal of the transponder unit, which can be detected by the transmitter-receiver unit and from which conclusions can be drawn concerning a wear condition of the friction element.

Thus, as a function of a position of the transponder unit relative to a friction surface contacted by the friction element, a shielding or an elimination of a shielding of the transponder unit can be effected. The elimination can take place by means of an abrasion of the surface of the friction element, for example a contact strip.

Further advantageous embodiments of the method arise from the feature descriptions of the dependent claims referring back to device claim 1.

In the following, a preferred embodiment of the invention is explained in detail with reference to the accompanying drawing.

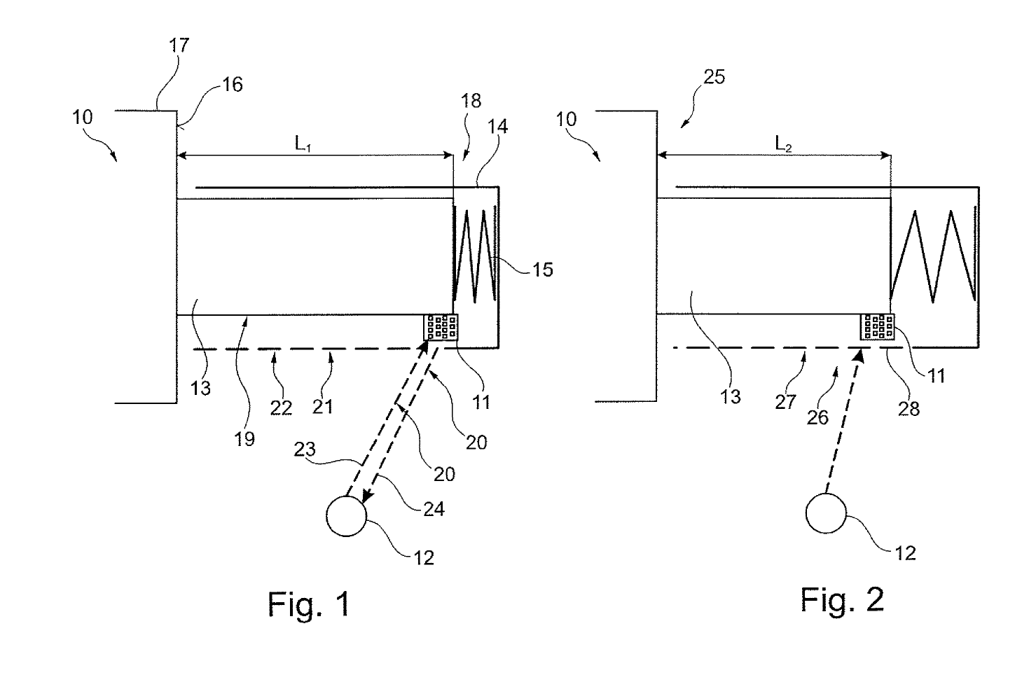

FIG. 1 shows a first embodiment of a wear detection system in a schematic illustration;

FIG. 2 shows the wear detection system according to the first embodiment with a changed wear condition as compared to FIG. 1;

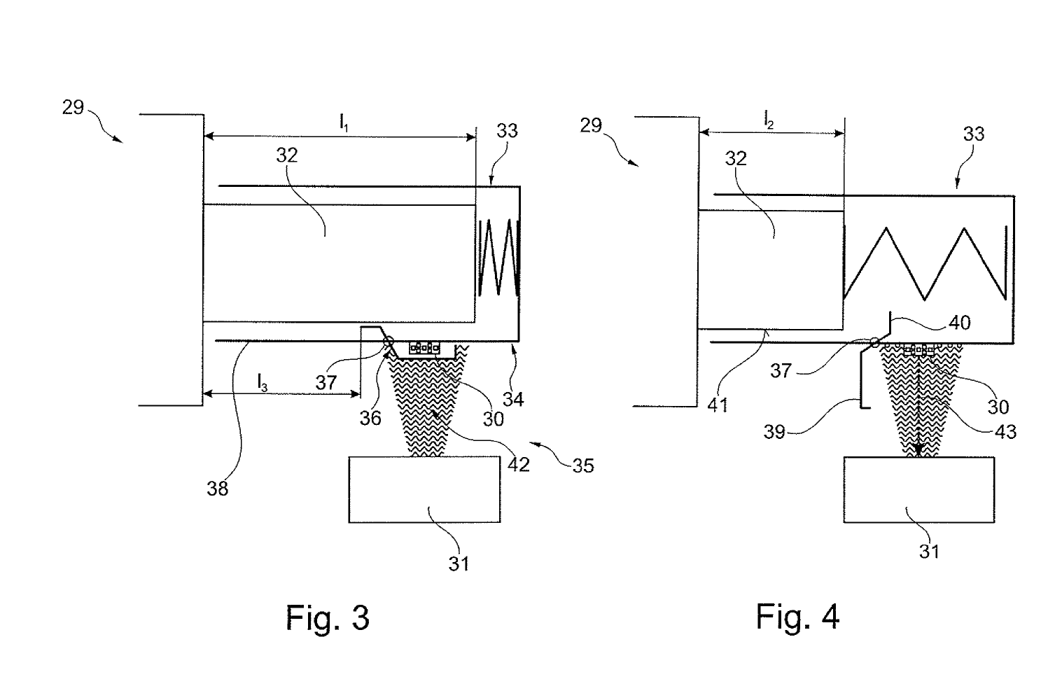

FIG. 3 shows a second embodiment of a wear detection system in a schematic illustration;

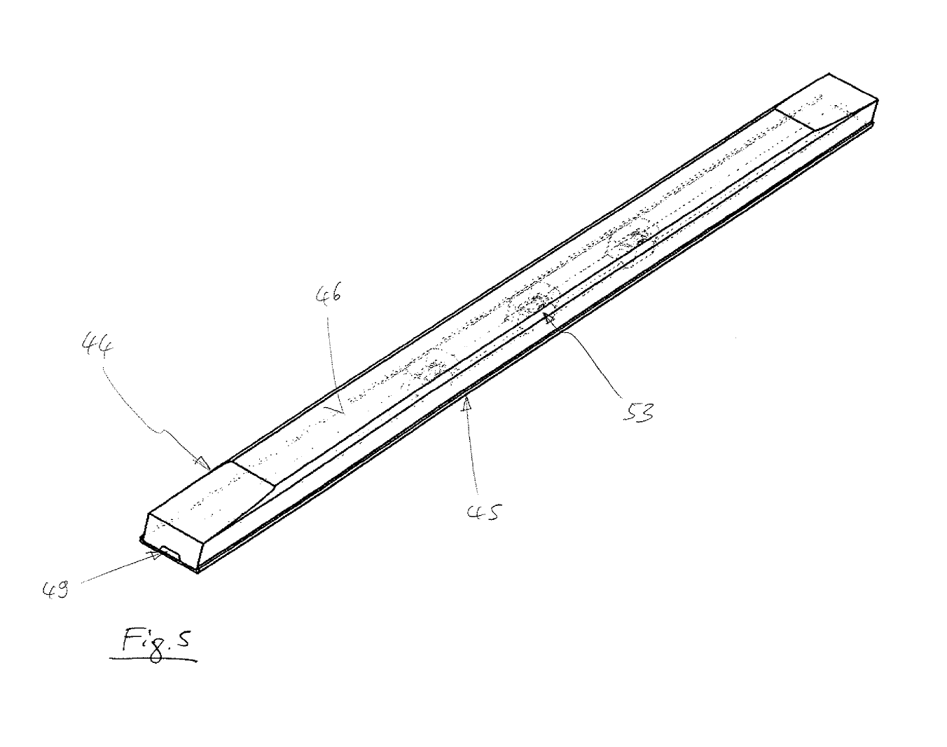

FIG. 4 shows the wear detection system according to the second embodiment with a changed wear condition as compared to FIG. 3;

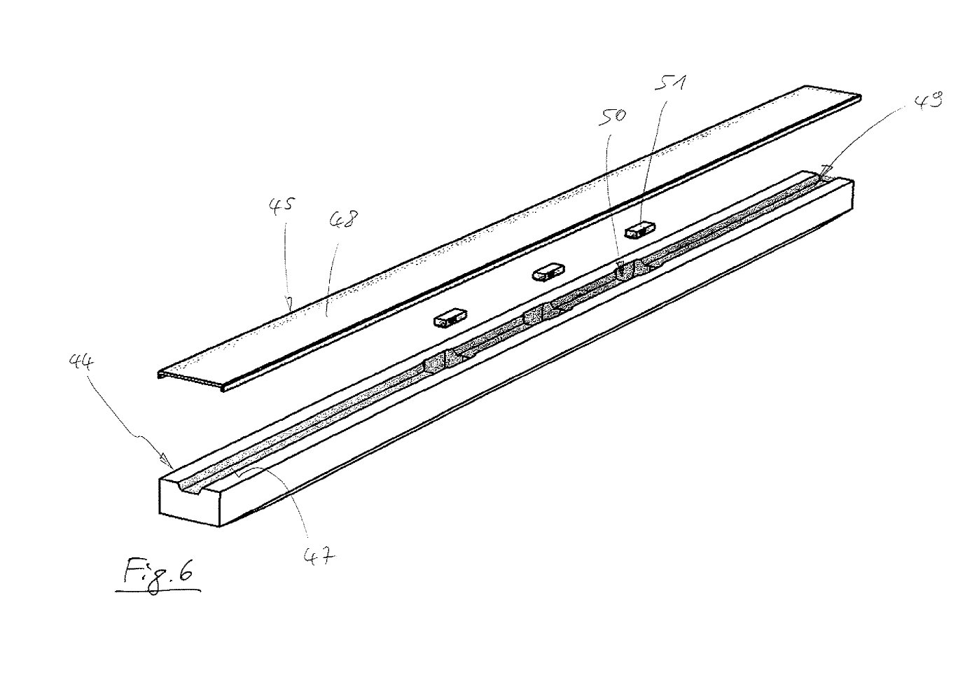

FIG. 5 shows a contact strip in a perspective view with a third embodiment of the wear detection system;

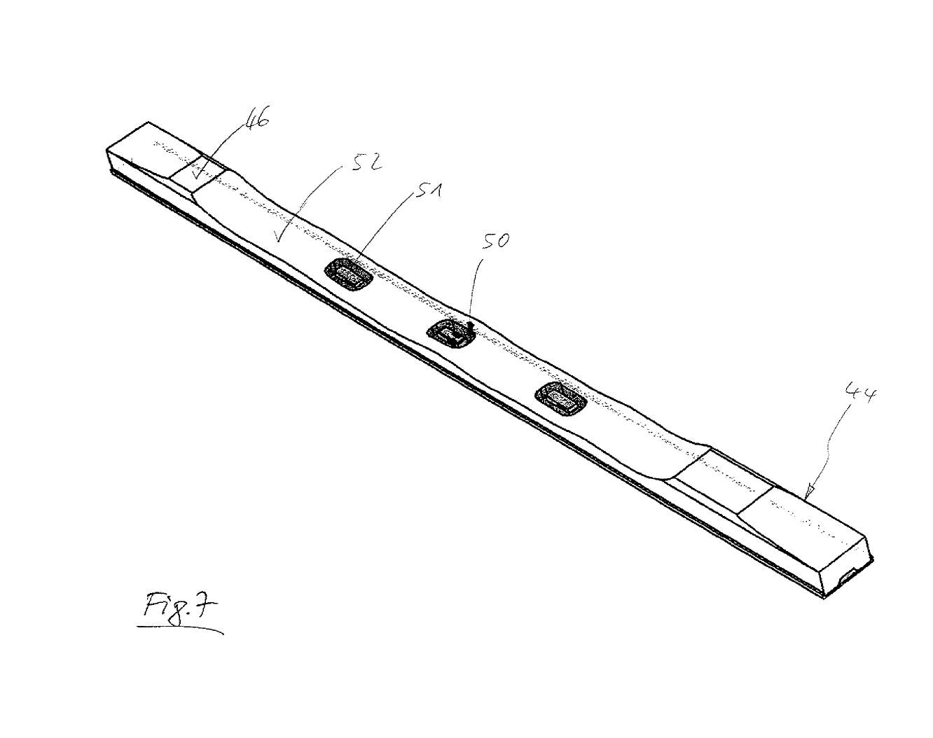

FIG. 6 shows an exploded illustration of the contact strip of FIG. 5;

FIG. 7 shows the contact strip of FIG. 5 in a worn state.

FIG. 1 shows a schematic illustration of a wear detection system 10 comprising a transponder unit 11, a transmitter-receiver unit 12 and a carbon brush 13. The carbon brush 13 is inserted into a support 14 for accommodating the carbon brush 13 in a longitudinally movable manner and is pressed by a spring 15 against a friction surface 16 of a slip ring 17 here illustrated in sections. At a rear end 18 of the carbon brush 13, the transponder unit 11 is glued onto a lateral surface 19 of the carbon brush 13. In the support 14, which is formed from a metallic material, openings 20, 21 and 22 are formed, with which the transponder unit 11 can be made to overlap as a function of a length L of the carbon brush 13.

As it can be taken from FIG. 1, at a length L1 of the carbon brush 13, the transponder unit 11 enters an area of the opening 20 such that the transmitter-receiver unit 12 can send a signal 23 to the transponder unit 11, which is received by the latter. In turn, the transponder unit 11 sends a signal 24 back to the transmitter-receiver unit 12, thus providing the transmitter-receiver unit 12 with the information that the transponder unit 11 has reached the area of the opening 20 and that, consequently, the carbon brush 13 must have a length L1.

In case of wear of a front end 25 of the carbon brush 13, the length L1 is reduced to the length L2 illustrated exemplarily here in FIG. 2. At length L2, the transponder unit 11 comes to overlap with a shielding device 26 formed by the support 14. In the present case, the shielding device 26 is formed by a wall 27 of the support 14 made of metal sheet. If, as illustrated in FIG. 2, the transponder unit 11 is directly covered by a wall portion 28, the transponder unit 11 is shielded against the transmitter-receiver unit 12 and against the signal 23 sent out by the transmitter-receiver unit and is unavailable to the transmitter-receiver unit 12. This information can now be processed in a higher-level machine control or also by the transmitter-receiver unit 12, wherein a conclusion can be drawn concerning the length L2 of the carbon brush 13 from the blocked communication between the transmitter-receiver unit 12 and the transponder unit 11.

FIGS. 3 and 4 show a wear detection system 29 comprising a transponder unit 30, a transmitter-receiver unit 31 and a carbon brush 32. In contrast to the wear detection system of FIGS. 1 and 2, here, the carbon brush 32 is inserted into a support 33 to whose outer surface 34 the transponder unit 30 is rigidly attached. A shielding device 35 is formed from a covering element 36 made of metal, which is supported pivotably about an axis 37 on a wall 38 of the support 33. The covering element 36 is formed in the manner of a rocker comprising an outer end 39 for shielding the transponder unit 30 and an inner end 40 for abutting against a lateral surface 41 of the carbon brush 32.

As it can be taken from FIG. 3, at a length 11 of the carbon brush 32, the inner end 4B of the covering element 36 abuts against the lateral surface 41 of the carbon brush 32 so that the outer end 39 of the covering element 36 shields the transponder unit 30 against electromagnetic radiation and against a signal 42 of the transmitter-receiver unit 31. If a length 13 of the carbon brush 32 is not reached anymore, the inner end 40 can no longer abut against the lateral surface 41 so that the covering element 36 is suddenly released due to a force influence (not illustrated) for example by a spring or a weight force, so that it is pivoted about the axis 37 and the outer end 39 no longer shields the transponder unit 30. The signal 42 can now be received by the transponder unit 30, the transponder unit 30 sending back a signal 43 to the transmitter-receiver unit 31. The transmitter-receiver unit 31 can now register an exceeding of a length 13 of the carbon brush 32 and, where applicable, pass the information on to a higher-level machine control.

A combining view of FIGS. 5 to 7 reveals a contact strip 44 of a rail vehicle for being contacted with a contact wire. The contact strip 44 substantially consists of a carbon material and is connected to a retaining device 45 of a support structure (not illustrated) or to a pantograph. A top side 46 of the contact strip 44 is formed to be contacted with the contact wire and a lower side 47 is provided with a copper layer so that a good transmission of electric energy from the contact strip 44 to the retaining device 45, which is formed as a U-shaped rail 48, is possible. In the lower side 47, further, a groove 49 is formed, into which a fracture sensor (not illustrated) can be inserted. By means of the fracture sensor, a possible fracture of the contact strip 44 can be detected and thus the contact strip 44 can be automatically lowered from the contact wire.

Further, three recesses 50 are formed in the lower side 47, into which transponder units 51 are inserted. The recesses 50 are covered by the material of the contact strip 44 or by the top side 46 thereof so that the transponder units 51 cannot communicate with a transmitter-receiver unit. Only when the contact strip 44 is completely worn, as illustrated in FIG. 7, the material of the contact strip 44 is abraded far enough by an abrasion of the top side 46 in that area so that an abraded surface 52 has emerged in which the recesses 50 are uncovered. The transponder units 51 in the recesses 50 can now communicate with the transmitter-receiver unit, which can be arranged for example at a bridge above a contact wire. The material of the contact strip 44 in the area of the top side 46 thus forms a shielding device 53 for the transponder units 51.

1. A wear detection system comprising:
at least one consumable friction element;
a transmitter-receiver unit;
a transponder unit communicating wirelessly with the transmitter-receiver unit; and
a shielding device at least partially shielding the transponder unit as a function of a wear condition of the friction element, such that communication between the transponder unit and the transmitter-receiver unit can be influenced.

2. The wear detection system according to claim 1, in which the transponder unit has a coding that can be received by the transmitter-receiver unit.

3. The wear detection system according to claim 1, in which the transponder unit is an RFID transponder unit.

4. The wear detection system according to claim 1, in which the friction element is a contact piece transmitting electric energy.

5. The wear detection system according to claim 1, in which e shielding device is arranged directly adjacent to the transponder unit.

6. The wear detection system according to claim 1, in which the wear detection system comprises a support structure which serves o movably position the friction element relative to a friction surface.

7. The wear detection system according to claim 6, in which the transponder unit is immovably connected to the friction element, the shielding device being formed by a least one opening in the support structure, the opening being formed such that in case of an at least partial overlapping of the opening with the transponder unit, a communication between the transponder unit and the transmitter-receiver unit is changed, blocked or enabled.

8. The wear detection system according to claim 7, in which the support structure comprises a plurality of openings, which form the shielding device.

9. The wear detection system according to claim 7, in which the transponder unit is arranged on a surface of the friction element.

10. The wear detection system according to claim 1, in which the transponder unit is arranged in the friction element.

11. The wear detection system according to claim 6, in which the transponder unit is immovably connected to the support structure, the shielding device being formed as a shielding element, which is arranged at the support structure and which can cover the transponder unit in a shielding manner or uncover it when a motion of the friction element relative to the support structure occurs.

12. The wear detection system according to claim 10, in which the friction element is a contact strip for transmitting electric energy from a contact wire to a vehicle.

13. A support structure for a wear detection system according to claims 6.

14. A method for detecting wear of at least one consumable friction element, said method comprising:
at least partially shielding a transponder unit communicating wirelessly with a transmitter-receiver unit, said shielding being a function of a wear condition of the friction element, such that communication between the transponder unit and the transmitter-receiver unit is influenced.

15. The method according to claim 14, in which at least partially shielding said transponder unit is performed by a shielding device that changes a permittivity of a spatial transmission range of the transponder unit.

16. The method according to claim 14, in which a wear-related dimensional change of the friction element causes a shielding or an elimination of a shielding of the transponder unit.

17. The method according to claim 14, in which a shielding or an elimination of a shielding of the transponder unit takes place as a function of a position of the transponder unit relative to a friction surface contacted by the friction element.
